(19) United States
(12) Patent Application Publication
(10) Pub. No.: US 2009/0029266 A1
(43) Pub. Date: Jan. 29, 2009

(54) MULTI-LAYER ALTERNATING PHASE SHIFT MASK STRUCTURE

(76) Inventors: Richard Schenker, Portland, OR (US); Allen B. Gardiner, Portland, OR (US)

Correspondence Address: COOL PATENT, P.C.;c/o INTELLEVATE, P.O. BOX 52050, MINNEAPOLIS, MN, 55402, US

(21) Appl. No.: 11/828,794

(22) Filed: Jul. 26, 2007

(51) Int. Cl. G03C 5/00

(52) U.S. Cl. 430/5

(57) ABSTRACT

A multi-layer alternating phase shift mask and associated techniques are generally described. In one example, a photomask includes a glass substrate, a compensating layer of material coupled with the glass substrate, the material having optical properties to compensate for thick mask effects, an absorber layer coupled with the compensating layer, the absorber layer having a first opening patterned therein, and the absorber layer and the compensating layer having a second opening patterned therein, the second opening having a depth selected to provide a desired phase shift, the compensating material having an index of refraction that is greater than the index of refraction of the glass substrate to reduce the depth of the second opening to provide a desired phase shift.

### TECHNICAL FIELD

Embodiments disclosed herein are generally directed to the field of semiconductor fabrication and, more particularly, to lithography photomasks.

### BACKGROUND

Conventional binary masks that control the amplitude of light incident upon a semiconductor wafer may be inadequate when integrated circuit (IC) features are very small. For example, under sub-wavelength conditions, additive amplitude effects, optical distortions as well as diffusion and loading effects of photosensitive resist and etch processes may cause printing aberrations. An alternating phase shift mask may modulate the projected light at the mask level by etching the glass of alternating features so that radiation passing through adjacent mask features is out of phase to improve resolution.

However, as the semiconductor industry reduces feature sizes even further, the alternating phase shift mask encounters structural and other printing challenges. For example, the etched glass depth of an alternating phase shift mask must remain constant in order to produce a half wavelength phase shift (i.e.—about 180 degrees out of phase) while patterned mask feature dimensions in the chrome, for example, continually shrink. This increases the aspect ratio of mask features and increases thick mask effects such as intensity and phase distortions due to mask topography. Current approaches of biasing etched glass regions compared to unetched glass regions to compensate for these effects may not be able to maintain edge placements through focus and phase errors for all structures of interest. Also, a biasing method forces minimum feature dimensions to become smaller on the mask. Other approaches including under-cutting the glass underlying the chrome to compensate for thick mask effects increases the risk of chrome or other material unintentionally lifting off the mask.

### BRIEF DESCRIPTION OF THE DRAWINGS

Embodiments disclosed herein are illustrated by way of example, and not by way of limitation, in the figures of the accompanying drawings in which like reference numerals refer to similar elements and in which:

FIG. 1 is a diagram of a multi-layer photomask structure, according to but one embodiment;

FIG. 2 is a diagram of an alternative multi-layer photomask structure, according to but one embodiment;

FIG. 3 is a diagram of another alternative multi-layer photomask structure, according to but one embodiment;

FIG. 4 is a diagram of yet another alternative multi-layer photomask structure, according to but one embodiment; and

FIG. 5 is a flow diagram of a method for fabricating a multi-layer photomask, according to but one embodiment.

It will be appreciated that for simplicity and/or clarity of illustration, elements illustrated in the figures have not necessarily been drawn to scale. For example, the dimensions of some of the elements may be exaggerated relative to other elements for clarity. Further, if considered appropriate, reference numerals have been repeated among the figures to indicate corresponding and/or analogous elements.

### DETAILED DESCRIPTION

Embodiments of a multi-layer alternating phase shift photomask are described herein. In the following description, numerous specific details are set forth to provide a thorough understanding of embodiments disclosed herein. One skilled in the relevant art will recognize, however, that the embodiments disclosed herein can be practiced without one or more of the specific details, or with other methods, components, materials, and so forth. In other instances, well-known structures, materials, or operations are not shown or described in detail to avoid obscuring aspects of the specification.

Reference throughout this specification to “one embodiment” or “an embodiment” means that a particular feature, structure or characteristic described in connection with the embodiment is included in at least one embodiment. Thus, appearances of the phrases “in one embodiment” or “in an embodiment” in various places throughout this specification are not necessarily all referring to the same embodiment. Furthermore, the particular features, structures or characteristics may be combined in any suitable manner in one or more embodiments.

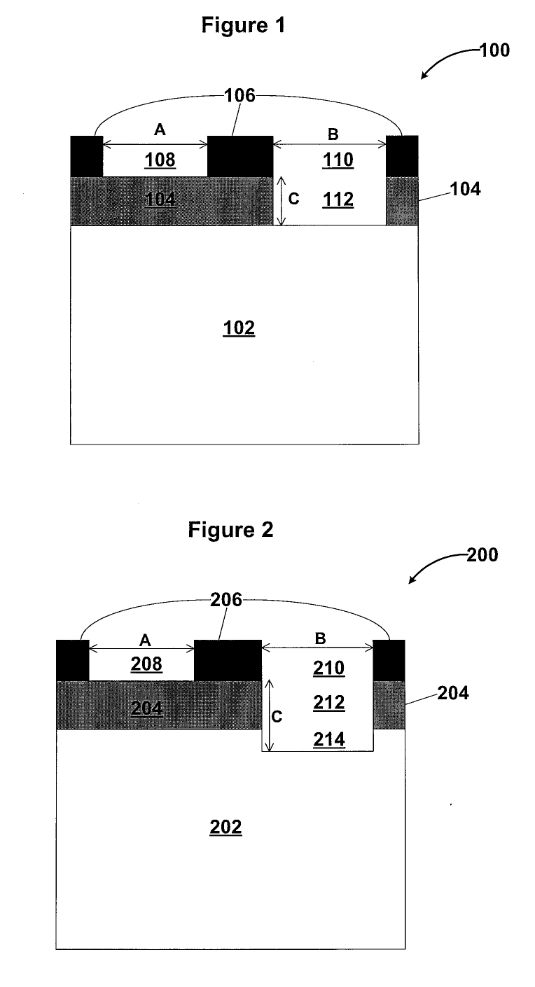

FIG. 1 is a diagram of a multi-layer photomask structure 100, according to but one embodiment. In an embodiment, a photomask 100 includes a glass substrate 102, a compensating layer 104, an absorber layer 106, a first opening 108 patterned into the absorber 106, the first opening having a width, A, a second opening 110 patterned into the absorber 106, the second opening 110 having a width, B, a second opening 112 patterned into the compensating layer 104, the second opening 112 having a depth, C, each coupled as shown.

In an embodiment, a compensating layer of material 104 is coupled with the glass substrate 102, the compensating material 104 having optical properties to compensate for thick mask effects. Thick mask effects may include intensity and/or phase distortions due to mask topography and other complications associated with high aspect ratios for features patterned into the mask. In an embodiment, a compensating layer material 104 has a higher absorption than a glass substrate 102 to increase intensity uniformity of radiation that passes through the first and second opening. Radiation may refer to electromagnetic radiation such as light, whether it is in the visible spectrum, or not. Although compensating material 104 may have an absorption that is greater than the absorption of a glass substrate 102, the absorption of the compensating material 104 may be generally low relative to most materials to provide an optical pathway for radiation. In an embodiment, compensating material 104 is compatible with radiation at 193 nm, 248 nm, 365 nm, and/or other commonly used lithographic wavelengths.

Alternating phase shift masks without a compensating material 104 may use width-biasing of alternating phase region openings to compensate for thick mask effects. Typically, the phase-shifted opening 110, 112 is widened to compensate for thick mask effects in the current state of the art. However, such biasing may force minimum feature dimensions to become smaller on the mask. In an embodiment, a compensating layer material 104 has a transmission between about 60% to 90% to reduce the need for width-biasing or to increase the width uniformity of the first 208 and second 210 openings and still provide a balanced image. In an embodiment, a compensating layer 104 enables a more similar width A and width B for a first 208 and second 210, 212 opening than for a mask where a compensating layer is not used.

According to an embodiment, a compensating layer 104 enables a mask 100 to have a larger minimum feature size than a mask without a compensating layer 104 while producing the same wafer feature size as a mask without a compensating layer 104. A compensating layer 104 may improve image contrast and sensitivity of wafer patterning to variations in mask size.

In an embodiment, a photomask 100 includes a compensating layer 104 having optical properties of about n=2.154 and k=0.077, where n is the refractive index and k is the absorption parameter, and where 193 nm immersion lithography conditions include about 80 nm pitch between mask features, 40 nm chrome 106 width, 1.35 numerical aperture, 0.12 sigma and polarized illumination. In an embodiment, an absorber layer 106 has about 50 nm thickness of a first absorber material with 193 nm optical parameters of about n=1.7 and k=1.93 adjacent to a second absorber material with optical parameters of about n=1.61 and k=1.11. In an embodiment, absorber 106 optical parameters for a first absorber material may be similar to chrome and a second absorber material may be similar to chrome oxide.

In an embodiment, a photomask 100 including a compensating layer 104 as above produces an image with improved contrast compared to a photomask without a compensating layer 104. Improved contrast may generally translate to improved lithography performance including reduced sensitivity to mask size non-uniformity and reduced sensitivity to exposure dose variation. In an embodiment, a photomask 100 including a compensating layer 104 as above may enable a minimum opening width, A, of about 150 nm, contrasted with a minimum opening width, A, of about 120 nm for a photomask without a compensating layer 104.

In an embodiment, a photomask 100 includes a compensating layer 104 of material coupled with a glass substrate 102, an absorber layer 106 coupled with the compensating layer 104, a first opening 108 patterned into the absorber layer 106, and a second opening 110 patterned into the absorber layer 106, the second opening 112 being further patterned into the compensating layer 104. In an embodiment, glass substrate 102 behaves as an etch stop layer for the etch of second opening 112 into compensating material 104.

In an embodiment, the second opening 112 has a selected depth, C, to provide a desired phase shift. In an embodiment, depth C is a selected etch depth beneath the absorber 106 to provide a phase shift of about 1 wavelength or about 180 degrees for radiation that passes through the second opening 110, 122 in comparison to radiation that passes through the first opening 108.

In an embodiment, a compensating material 104 has an index of refraction that is greater than the index of refraction of the glass substrate 102 to reduce the second opening 112 depth, C, required to provide a desired phase shift. For example, a mask without such compensating layer 104 would typically be etched at a greater depth, C, into the glass substrate 102 creating a larger aspect ratio for patterned mask features. In an embodiment, compensating layer 104 enables an alternating phase shift mask 100 with shallower etch depth, C, in the phase shifting openings 112. A shallower etch depth, C, may generally enable a more simple and more uniform etch depth distribution. A shallower etch depth, C, may enable a smaller aspect ratio (height/width) of patterned mask features, making the sidewalls of the features less susceptible to variations in the wall angle of an applied etch process. Such embodiment may also compensate for other thick mask effects such as phase and intensity non-uniformities.

In an embodiment, a mask 100 including a compensating layer 104 reduces the depth, C, required to achieve a desired phase shift. The depth, C, may be proportional to the difference of the index of the etched material and air according to the following relationship where PS is a desired phase shift, C is the required depth to achieve the desired phase shift, λ is the wavelength of radiation, and n is the refractive index of the etched material 104:

C=((PS/360)*λ)/(n−1)

For example, a desired phase shift of 165 degrees, a wavelength of 193.4 nm, and a compensating material 104 with a refractive index of 2.155 would require an etch depth, C, of about 77 nm. In contrast, a similar mask without a compensating material would require an etch depth of about 158 nm [((165/360)*193.4)/(1.56−1)]. A compensating material 104 having a thickness of about 77 nm having n=2.154 and k=0.077 would produce a bulk transmission of about 68%.

In an embodiment, a compensating layer 104 material includes silicon oxynitride, silicon carbide, suitable combinations thereof, or other materials that accord with embodiments disclosed herein for a compensating material. Optical properties of a compensating layer material such as silicon oxynitride (SiON) may be tuned by varying process conditions and relative amounts of the constituent elements. Optimal optical properties of a compensating layer 104 may vary depending upon the particular lithography application and wavelength.

In an embodiment, a glass substrate 102 includes quartz, silica, fused silica, modified fused silica, and/or any other suitable transparent material that accords with photomask specifications, or suitable combinations thereof. Other considerations for a substrate 102 material may include low coefficient of thermal expansion, low absorption, high transmission, and low reactivity among others. In an embodiment, absorber 106 material includes chrome, chrome oxide, tungsten, amorphous silicon, or suitable combinations thereof, or any other suitable opaque material to block the passage of radiation in defined areas 106 of a photomask.

FIG. 2 is a diagram of an alternative multi-layer photomask structure 200, according to but one embodiment. In an embodiment, a photomask 200 includes a glass substrate 202, a compensating layer 204, an absorber layer 206, a first opening 208 patterned into the absorber 206, the first opening having a width, A, a second opening 210 patterned into the absorber 206, the second opening 210 having a width, B, a second opening 212 patterned into the compensating layer 204, the second opening 212 having a depth, C, and a second opening 214 patterned into the glass substrate, each coupled as shown.

In an embodiment, a photomask 200 includes a second opening 210, 212, 214 that is patterned into the absorber 206, the compensating layer 204, and the glass substrate 202. In an embodiment, the second opening 214 is only partially etched into the glass substrate 202 as depicted. In an embodiment, a second opening 214 is patterned into the glass substrate 102 when a desired thickness is difficult to achieve or reproduce for a compensating layer 204. In an embodiment, the thickness of compensating layer 204 is targeted to be slightly thinner than needed to achieve a desired phase shift and the glass substrate 202 is etched to a depth, C, to provide the remainder of the desired phase shift. In an embodiment, a second opening 214 is patterned into the glass substrate because the interface between the compensating material 204 and the glass substrate may have undesirable optical properties. In an embodiment, a second opening 214 is patterned at least partially into the glass substrate 202 to remove glass substrate 202 surface that may have been damaged during the etch of a compensating layer 204 or to ensure that the compensating material 204 is completely removed from the second opening 212, 214.

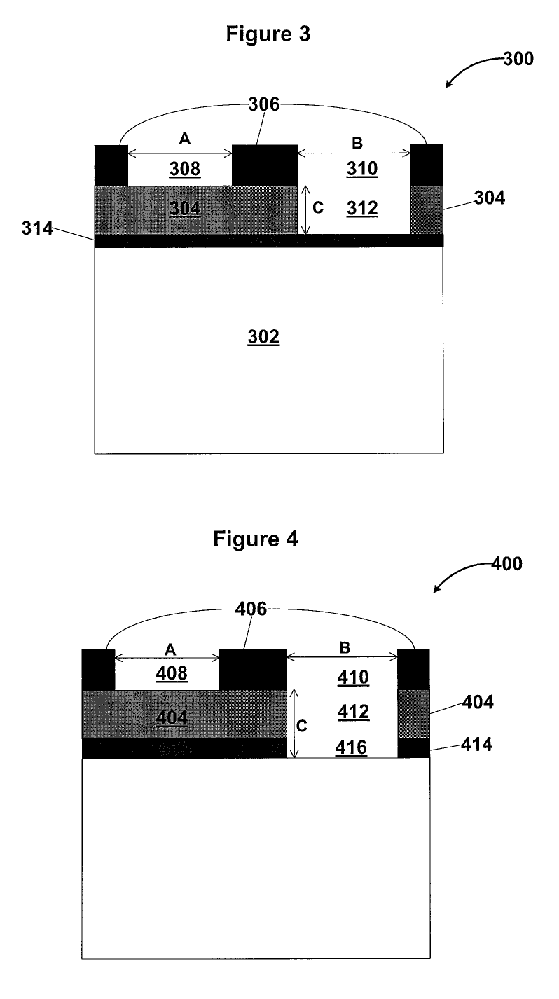

FIG. 3 is a diagram of another alternative multi-layer photomask structure 300, according to but one embodiment. In an embodiment, a photomask 300 includes a glass substrate 302, an etch stop layer 314, a compensating layer 304, an absorber layer 306, a first opening 308 patterned into the absorber 306, the first opening having a width, A, a second opening 310 patterned into the absorber 306, the second opening 310 having a width, B, a second opening 312 patterned into the compensating layer 304, the second opening 312 having a depth, C, each coupled as shown.

In an embodiment, a photomask 300 includes an etch stop layer 314 coupled with the glass substrate 302 and the compensating layer 304 such that the etch stop layer 314 is disposed between the glass substrate 302 and the compensating layer 304. In an embodiment, a photomask 300 includes a second opening 314 that is patterned into the absorber 306 and into the compensating layer 304, stopping at the etch stop layer 314. The etch stop layer 314 may serve as an etch stop layer 314 for compensating layer 304 etching. An etch stop layer 314 may be desirable if the glass substrate 302 does not function well as an etch stop layer for compensating material 304 etching (i.e.—if the glass substrate 302 is undesirably etched during the compensating material 304 etch).

In an embodiment, an etch stop layer 314 of uniform thickness does not affect the contrast and intensity balancing between a first opening 308 and a second opening 310, 312 because any passing radiation must pass through a similar thickness of etch stop layer 314 through either opening 308, 310. In an embodiment, etch stop layer 314 drops the average radiation intensity at the wafer level. In an embodiment, an etch stop layer 314 material includes TiN, TaN, and TaHf, but is not limited to these materials only and may include any suitable etch stop material 314. An etch stop material 314 may be selected according to the etch selectivity of compensating material 304 compared with a candidate etch stop material 314 and/or the optical properties of the etch stop material.

FIG. 4 is a diagram of yet another alternative multi-layer photomask structure 400, according to but one embodiment. In an embodiment, a photomask 400 includes a glass substrate 402, an etch stop layer 414, a compensating layer 404, an absorber layer 406, a first opening 408 patterned into the absorber 406, the first opening having a width, A, a second opening 410 patterned into the absorber 406, the second opening 410 having a width, B, a second opening 412 patterned into the compensating layer 404, the second opening 412 having a depth, C, and a second opening 416 patterned into the etch stop layer 414, each coupled as shown.

In an embodiment, a photomask 400 includes a second opening 410, 412, 416 that is patterned into the absorber 406, the compensating layer 404, and the etch stop layer 414. In an embodiment, the etch depth, C, of the second opening 412, 416 is selected to provide a desired phase shift. In another embodiment, the thickness of etch stop layer 414 is selected such that removal of etch stop material 414 in the second opening 416 provides an etch depth, C, that enables a desired phase shift. In an embodiment, the combined optical properties of compensating material 404 and etch stop material 414 are considered to select an etch stop material 414 and thickness that balances intensity at the wafer.

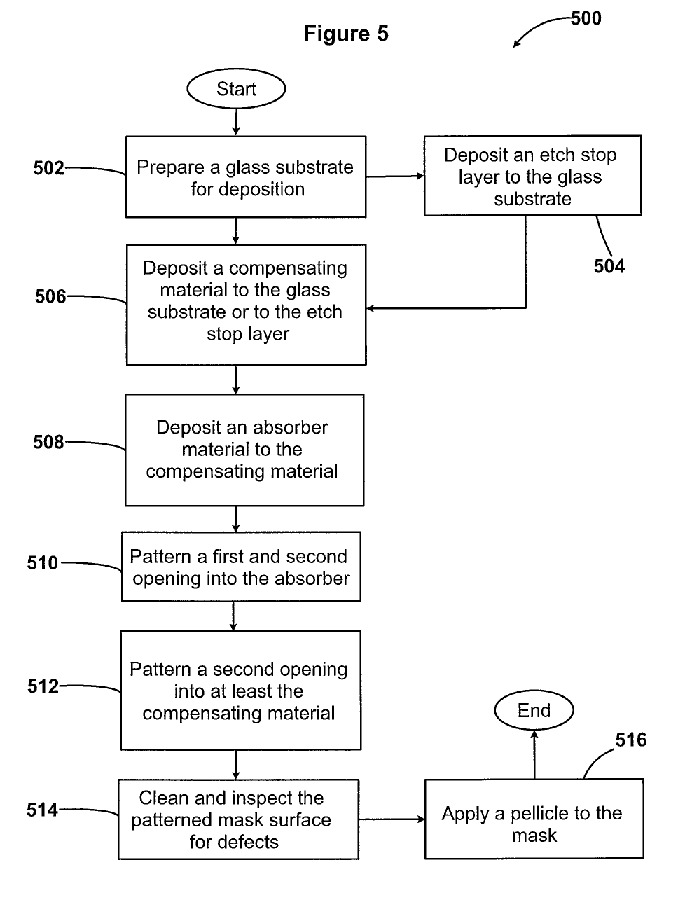

FIG. 5 is a flow diagram of a method for fabricating a multi-layer photomask 500, according to but one embodiment. In an embodiment, a method 500 includes preparing a glass substrate for deposition, optionally depositing an etch stop layer to the glass substrate 504, depositing a compensating material to a glass substrate or to an etch stop layer, 506, depositing an absorber material to the compensating material 508, patterning a first and second opening into the absorber 510, patterning a second opening into at least the compensating material 512, cleaning and inspecting the patterned mask surface for defects 514, and applying a pellicle to the mask 516, with arrows providing a suggested flow. Although arrows depict a suggested flow, the actions associated with method 500 need not necessarily be performed in the order suggested in various embodiments, or performed at all, in other embodiments. For example, depositing an etch stop layer 504 may not be necessary if the glass substrate behaves as an etch stop layer for a selected compensating material 506.

In an embodiment, patterning a second opening into at least the compensating material 512 only partially removes the compensating material. In another embodiment patterning a second opening into at least the compensating material 512 substantially removes any compensating material between an opening in the absorber and the glass substrate. In an embodiment, patterning a second opening into at least the compensating material 512 includes an etch selective to the glass substrate such that intentionally etching for a longer time ensures that all of the compensating material is removed without removing a substantial amount of the glass substrate. In an embodiment, the glass substrate is used as an etch stop for a compensating material etch. Such embodiment may mitigate for non-uniformities in the etch rate of compensating material 512 by over-etching. Over-etching may result in a more uniform phase depth across the underlying surface of the etch. In other embodiments, patterning a second opening into at least the compensating material 512 includes patterning a second opening into a glass substrate as well. Patterning a second opening into the glass substrate 512 may accord with other embodiments already described for a photomask 200.

In an embodiment, depositing an etch stop layer to the glass substrate 504 is accomplished such that the etch stop layer is between the glass substrate and the compensating layer. In an embodiment, etch stop layer includes TiN, TaN, TaHf, any other suitable material in accordance with other embodiments for an etch stop layer already described, or any suitable combination thereof. Depositing an etch stop layer may be accomplished using any suitable deposition method.

In an embodiment, patterning a second opening into at least the compensating material 512 includes etching away substantially all compensating material between the etch stop layer and the second opening in the absorber. In another embodiment, patterning a second opening into at least the compensating material 512 includes etching into the etch stop layer to substantially remove the etch stop layer in the second opening.

In an embodiment, each different material in the mask structure requires a separate etch chemistry. For example, patterning 510, 512 may include etching the absorber with a first etch chemistry, etching the compensating material with a second etch chemistry, etching the glass substrate with a third etch chemistry, and etching the etch stop layer with a fourth etch chemistry. In another embodiment, the same etch chemistry is used for at least two of the four materials previously described. An etch chemistry may depend on the chemical nature and/or thickness of the materials used for the various layers described.

In an embodiment, depositing materials to a glass substrate 504, 506 and/or stacking deposited materials 506, 508 is accomplished using any suitable deposition method. Patterning a first and second opening 510 into the absorber may be accomplished by e-beam or lithographic exposure process using another mask, resist and/or etching to define the first and second openings, or any suitable patterning method. Patterning a second opening into at least the compensating material 512 may be accomplished via a lithographic process, a laser writer, or any other suitable patterning method.

In an embodiment, a method 500 includes coupling a compensating layer with a glass substrate 506, the compensating layer having optical properties to compensate for thick mask effects, depositing an absorber layer to the compensating layer 508, patterning a first and second opening into the absorber 510, and patterning the second opening into the compensating layer material 512. In an embodiment, the second opening has a selected depth to provide a desired phase shift. In another embodiment, the compensating layer has an index of refraction that is greater than the index of refraction of the glass substrate to reduce the second opening depth required to provide a desired phase shift. In another embodiment, method 500 further includes cleaning and inspecting the patterned mask surface for defects 514.

In an embodiment, coupling a compensating layer 506 includes a compensating material having a higher absorption than the glass substrate to increase intensity uniformity of radiation that passes through the first and second opening. In another embodiment, compensating material has a transmission between about 60% to 90% to reduce the need for width-biasing or to increase the width uniformity of the first and second openings. In another embodiment, elements and actions associated with method 500 accord with other embodiments already described in relation to a photomask in FIGS. 1-4.

An apparatus that executes the above-specified process 500 is also disclosed. The apparatus comprises a machine-readable storage medium having executable instructions that enable the machine to perform the actions in the specified process.

Various operations may be described as multiple discrete operations in turn, in a manner that is most helpful in understanding the invention. However, the order of description should not be construed as to imply that these operations are necessarily order dependent. In particular, these operations need not be performed in the order of presentation. Operations described may be performed in a different order than the described embodiment. Various additional operations may be performed and/or described operations may be omitted in additional embodiments.

The above description of illustrated embodiments, including what is described in the Abstract, is not intended to be exhaustive or to limit to the precise forms disclosed. While specific embodiments and examples are described herein for illustrative purposes, various equivalent modifications are possible within the scope of this description, as those skilled in the relevant art will recognize.

These modifications can be made in light of the above detailed description. The terms used in the following claims should not be construed to limit the scope to the specific embodiments disclosed in the specification and the claims. Rather, the scope of the embodiments disclosed herein is to be determined entirely by the following claims, which are to be construed in accordance with established doctrines of claim interpretation.

What is claimed is:

1. A photomask comprising:
a glass substrate;
a compensating layer of material coupled with the glass substrate, the material having optical properties to compensate for thick mask effects;
an absorber layer coupled with the compensating layer;
the absorber layer having a first opening patterned therein; and
the absorber layer and the compensating layer having a second opening patterned therein, the second opening having a depth selected to provide a desired phase shift, the compensating material having an index of refraction that is greater than the index of refraction of the glass substrate to reduce the depth of the second opening to provide a desired phase shift.

2. A photomask according to claim 1 wherein the compensating layer material has a higher absorption than the glass substrate to increase uniformity of radiation intensity that passes through the first and second opening.

3. A photomask according to claim 1 wherein the compensating layer material has a transmission between about 60% to 90% to reduce a need for width-biasing or to increase width uniformity of the first and second openings.

4. A photomask according to claim 1 wherein the second opening is further patterned into the glass substrate.

5. A photomask according to claim 1 further comprising:
an etch stop layer coupled with the glass substrate and the compensating layer such that the etch stop layer is between the glass substrate and the compensating layer.

6. A photomask according to claim 5 wherein the second opening is further patterned into the etch stop layer.

7. A photomask according to claim 5 wherein the etch stop layer comprises TiN, TaN, TaHf, or suitable combinations thereof.

8. A photomask according to claim 1 wherein the glass substrate comprises quartz, fused silica, modified fused silica, or suitable combinations thereof, the absorber layer comprises chrome, chrome oxide, tungsten, amorphous silicon, or suitable combinations thereof, and the desired phase shift is about 180 degrees.

9. A photomask according to claim 1 wherein the compensating layer material comprises silicon oxynitride, silicon carbide, or suitable combinations thereof.

10. A method comprising:
coupling a compensating layer with a glass substrate, the compensating layer having optical properties to compensate for thick mask effects;
depositing an absorber layer to the compensating layer;
patterning first and second openings into the absorber layer;
patterning the second opening into the compensating layer material, the second opening having a depth selected to provide a desired phase shift, the compensating layer material having an index of refraction that is greater than the index of refraction of the glass substrate to reduce the depth of the second opening to provide a desired phase shift; and
cleaning and inspecting the patterned mask surface for defects.

11. A method according to claim 10 wherein coupling a compensating layer comprises coupling a compensating layer having a higher absorption than the glass substrate to increase intensity uniformity of radiation that passes through the first and second opening and having a transmission between about 60% to 90% to reduce a need for width-biasing or to increase width uniformity of the first and second openings, or combinations thereof.

12. A method according to claim 10 further comprising:
patterning the second opening into the glass substrate.

13. A method according to claim 10 further comprising:
depositing an etch stop layer to a glass substrate such that the etch stop layer is between the glass substrate and the compensating layer.

14. A method according to claim 13 further comprising:
patterning the second opening into the etch stop layer, the etch stop layer comprising TiN, TaN, TaHf, or suitable combinations thereof.

15. A method according to claim 10 wherein the glass substrate comprises quartz, fused silica, modified fused silica, or suitable combinations thereof, the absorber layer comprises chrome, chrome oxide, tungsten, amorphous silicon, or suitable combinations thereof, and the compensating layer material comprises silicon oxynitride, silicon carbide, or suitable combinations thereof.
